(19) United States
(12) Patent Application Publication
(10) Pub. No.: US 2023/0058145 A1
(43) Pub. Date: Feb. 23, 2023

(54) Pelvic floor pain relief device and method of use

(71) Applicant: LEAD MANAGEMENT CONSULTING, INC., SASKATOON (CA)

(72) Inventor: Jana DANIELSON, Saskatoon (CA)

(21) Appl. No.: 17/759,468

(22) PCT Filed: Feb. 5, 2021
(86) PCT No.: PCT/CA2021/050135

§ 371 Date: Jul. 26, 2022

(30) Foreign Application Priority Data
Feb. 6, 2020 (CA) 3071359

(51) Int. Cl. A61H 15/00

(52) U.S. Cl. CPC A61H 15/00; A61H 2201/0103; A61H 2015/0042; A61H 2201/1284; A61H 2201/1628; A61H 2203/0425

(57) ABSTRACT

A pelvic floor pain relief device for use by humans. The device is spherical, and comprised of three layers. The core of the device is a compact compressible spherical core, having a compressibility rating sufficient to substantially support the weight of a human sitting thereon while allowing but minimizing the deformation of the sphere under the human load. A strengthening layer, consisting of randomly wound filament material, is wound around the exterior of the compressible spherical core to further minimize the deformation of the sphere in use. Finally, an exterior protective layer retains the filament of the strengthening layer in relation to the sphere and provides a cleanable surface. The method of use of the device is also disclosed.

### BACKGROUND

Pelvic floor muscles are the layer of muscles supporting the pelvic organs such as the bladder, bowel, uterus and the like. These muscles stand to the bottom of the pelvic area and provide support for the pelvic organs lying in that area. Pelvic floor muscles are also important number of other reasons including working with the abdominal and back muscles to support the spine, support for the carriage of a baby during pregnancy and the like.

Through old age, obesity or for other miscellaneous reasons pelvic floor muscles can either be too weak or too tight resulting in the experience of pelvic floor pain by the individual. Once a pelvic floor pain or dysfunction is diagnosed, there are many approaches to treatment of that pain and rehabilitation of the pelvic floor muscles.

Pelvic therapy is a field that has been identified and developed which relates the assessment and treatment of various conditions involving the pelvic floor muscles and surrounding areas. These muscles are important for many purposes including bladder and bowel control, sexual function in pregnancy and the like and pelvic therapy can help to treat various muscle conditions causing pain in this area. Traditional treatment techniques in this area include manual therapy to treat soft tissues as well as exercise programs, electrical stimulation devices and the like. Manual therapy may be uncomfortable for some patients, and electrical stimulation devices have in the past being of mixed effect and are expensive and complicated for manufacturing use, primarily requiring their use directly under the supervision of pelvic therapy professionals.

Some of the exercise programs which have been used by pelvic therapy professionals with patients in the past include the use of large, soft squatting ball type devices which are used in setting devices between the individual and the floor. These devices are typically up to 24 inches in diameter and allow the individual to sit in a squatting position in relation to the floor. These squatting balls typically consist of a single layer compressible spherical core which is not overly hard or overly inflated, resulting in substantial compression of the squatting ball when the individual sits on it. Another limitation to the use of these devices is their size—they cannot easily be transported and are not particularly portable. If it were possible to provide a device that would enhance the efficacy of a squatting or sitting exercise on a ball type device, that were sufficiently compact and portable to allow for transportation and movement etc., it is believed that this would be desirable in industry.

If there were a simple device available that could be used by humans experiencing pelvic floor pain to rehabilitate or strengthen their pelvic floor muscles, either under the supervision of a trainer or kinesiology professional or in a home environment, it is believed that this would be a commercially viable and desirable product. It is more particularly contemplated that the creation of a compact spherical pelvic floor pain treatment device that could be used to address the pelvic floor muscles and pain of the user would be desirable.

### SUMMARY OF THE INVENTION

The invention comprises a pelvic floor pain relief device for use by humans. The device is a compact spherical or ball shaped device which, when sat upon by a user with the ball in an appropriate position, will allow for the alleviation of pelvic floor pain and the potential rehabilitation of pelvic floor muscles.

The compact nature of the device will allow for its easy transport, storage and the like.

The pelvic floor pain relief device of the present invention represents a significant enhancement to currently available rehabilitation practices and currently available exercise program equipment.

The pelvic floor pain relief device of the present invention achieves its objectives comprising a multilayer compressible spherical core. Most embodiments of the device will likely consist of three layers, although it will be understood by those skilled in the art of the design of such materials and products that it may be determined that additional layers being added to the device could further enhance its strength or performance and all such approaches are also contemplated within the scope of the present invention.

The innermost component of the device of the present invention is a compact compressible spherical core, sized for use and placement between the hips or in a sitting position by the user. The compressible spherical core could comprise an inflated bladder in some embodiments, or in other embodiments might comprise a compressible foam or the like. In either case, the compressible spherical core would be of the desired compressible size, such that it could fit between the hips of the user in use and have sufficient compressibility parameters to allow for no more than a desirable degree of deformity of the sphere when the user sat on the device. Any type of a compressible spherical core of this type and of a means are method of manufacture accomplishing this objective will be understood to be within the intended scope of the present invention.

In some embodiments the compressible spherical core might be inflatable by the user to set the desired degree of hardness or deformability for the device, where in others the level of inflation of an inflatable spherical core might be factory set to a desirable level. Both such approaches are contemplated within the scope of the present invention.

Around the outside of the compressible spherical core would be applied at least one strengthening layer consisting of randomly wound filament material, which is wound around the exterior of the compressible spirit manufacture to achieve the desired allowable deformation profile or compressibility of the device. Many different types of a filament material could be used to create a randomly wound strengthening layer around the compressible spherical core, including stretchable nylon material and the like, and any type of a filament which could be wrapped in a randomly wound strengthening layer around the compressible spherical core is contemplated within the scope of the present invention. More than one strengthening layer could also be used in certain embodiments of the device without departing from the intended scope hereof.

The third component of the device of the present invention is an exterior protective layer applied around the device, to retain the filament of the strengthening layer in relation to the compressible spherical core and to provide a desirable and cleanable outer surface to the device. The exterior protective layer could have texture applied to it to allow for better grip ability by the user in use of the device, or in other embodiments might be smooth. The method of applying or manufacturing the exterior protective layer will be understood to those skilled in the art of manufacturing in this area and any type of exterior protective layer regardless of its material and method of manufacture or application which achieves the objective of providing a cleanable exterior and a retaining layer around the randomly wound filament of the strengthening layer is contemplated within the scope of the present invention.

The pelvic floor pain relief device of the present invention would be manufactured by first selecting the compressible spherical core for the interior of the device, and in the case of for example a inflatable bladder, inflating same to the desired internal pressure and size. The strengthening layer would then be applied to the exterior of the compressible spherical core by randomly winding at least one selected filament material around the exterior of the compressible spherical core to a desired thickness and strengthening quality. Once the strengthening layer or layers were applied to the exterior of the compressible spherical core, the exterior protective layer would be applied around the exterior of the strengthening layer. Various means of application or installation of the exterior protective layer will be understood to those skilled in the art of plastics and related manufacturing. The device, consisting of these three layers, can then be used for pelvic floor muscle pain alleviation and rehabilitation.

The compressibility or deformability of the compressible spherical core in the interior of the device could be selected to allow for the desired amount of strength depending upon the weight for example of the user, and/or to provide for a particular anticipated desired degree of deformability of the device in use. If it was desired for some users or in some applications to provide a device that was more deformable, such that it would flatten the load of the user, that could be accommodated in the compressibility strength of the compressible spherical core in the interior of the device—and for example in other embodiments in which less deformity or flattening was desired of the device when under the load of the user, the compressible spherical core could be more rigid and have a lower compressibility potential.

The deformability of the compressible spherical core under the load of a user will also be impacted by the thickness and pattern of orientation of the randomly wound filament strengthening layer. The strengthening layer could be applied in thicker or thinner thickness depending upon the amount of restriction in the deformability of the compressible spherical core in the interior of the device which was required.

### DESCRIPTION OF THE DRAWINGS

To easily identify the discussion of any particular element, the most significant digit or digits in a reference number refer to the figure number in which that element is first introduced. The drawings enclosed are:

FIG. 1 is a perspective drawing of a pelvic floor pain relief device in accordance with one embodiment of the present invention;

FIG. 2 is a cutaway cross-section of the device of FIG. 1;

FIG. 3 is a perspective view of the interior compressible spherical core of the device of FIG. 1;

FIG. 4 is a perspective view of the strengthening filament layer of the device of FIG. 1;

FIG. 5 is a perspective view of the device of FIG. 1 being partially deformed on a surface, as if being under the load of human weight; and

FIG. 6 is a front view of the device of FIG. 1 with a user sitting on the device, showing the utility and use of the device; and

FIG. 7 is a side view of FIG. 6.

### DETAILED DESCRIPTION OF ILLUSTRATED EMBODIMENTS

As outlined herein, the present invention comprises a device for use in the treatment of pelvic floor muscle pain. It represents a considerable improvement over current state devices and methods which are used for exercise program type treatment of these conditions, either in a home environment by the user suffering from such pain or in a training or pelvic treatment environment.

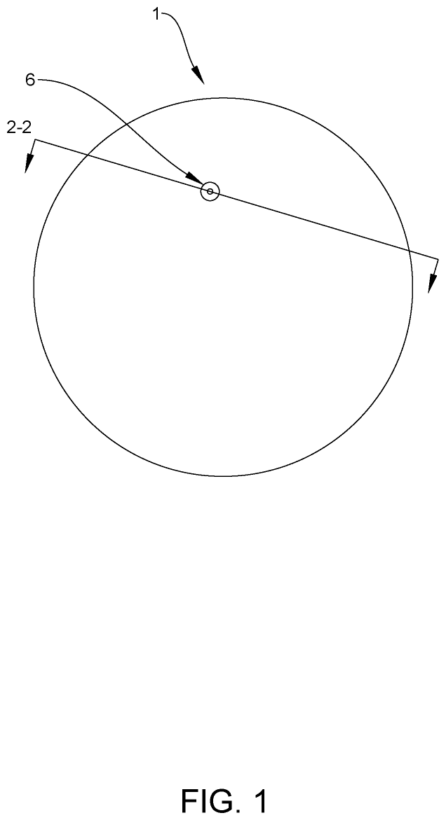

FIG. 1 shows a perspective view of a completed pelvic floor pain treatment device in accordance with the present invention. The device 1 comprises a multilayer compressible sphere capable of bearing the weight of a human with only a desired or minimized the formation of the sphere when under such load. The device 1 is compact in size and it will allow a user to sit on it for the purpose of the treatment or rehabilitation of pelvic floor muscle pain while allowing for simple storage or transportation and represents a substantial enhancement over manual treatment devices that are currently available. The device 1 as shown has a smooth exterior surface, although it will be understood that the device 1 could also have a textured exterior surface in certain embodiments and both such approaches are contemplated within the scope of the present invention.

The device 1 shown in FIG. 1 also shows an inflation nipple 6 which would be useful for the user to adjust the level of inflation of the device 1 to a desired level of hardness or deformability.

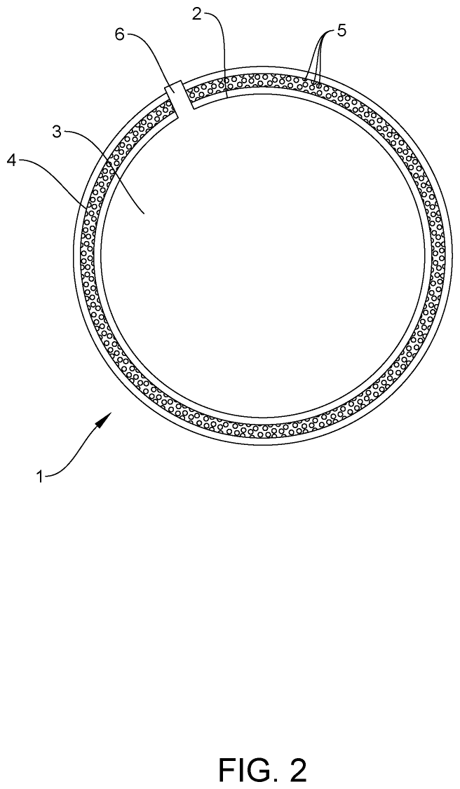

Referring to FIG. 2 there is shown a cutaway cross-sectional view of the device 1 of FIG. 1, along line 2-2. This Figure is intended to show a cross-sectional profile of the device 1 including the layers of the device as otherwise outlined. The interior and innermost layer or component of the device 1 is a compressible spherical core 2. The spherical core 2 of the device would comprise either an inflated bladder, such as a compressible nylon or rubber bladder or the like, having a layer strength and an interior inflation pressure to permit for maximized strength to the weight of the anticipated user and allow for only a desired amount of the formation when a user sat on the device 1. The inflated void in the interior of the core 2 is shown at 3. As outlined above, in other cases rather than using an inflatable bladder as the spherical core 2, a compressible solid foam sphere 2 could be used, again selected based upon using a material of manufacture having desired degree of deformability or compressibility. Both such approaches are contemplated within the scope of the present invention.

The next layer of the device which is shown is a strengthening layer 4. The strengthening layer 4 comprises at least one wound filament 5 which is randomly wound around the spherical core 2. The strengthening layer 4 comprises a sufficient quantity of randomly wound filament 5 to provide added strength to the spherical core 2 and to achieve the desired degree of compressibility and deformability of the device 1 when used. The strengthening layer 4 might comprise a single randomly wound layer of filament 5, or might comprise a plurality of individually wound layers of one or more types of filament 5 and both such approaches are contemplated within the scope of the present invention.

The filament 5 can comprise any type of a stretchable filament which could be used to apply a randomly wound and tightly fitting strengthening layer 4 around the spherical core 2. Any type of the filament 5 which when randomly wound around the spherical core 2 will provide added strength and deformability management to the device 1 when sat upon by the user is contemplated within the scope of the present invention.

The outer layer 7 of the device 1 is a retaining covering layer which retains the filament 5 and the strengthening layer 4 and provides a cleanable outer surface to the device 1.

The inflation nipple 6 is also shown extending through the layers of the device 1 into the inflation void 3.

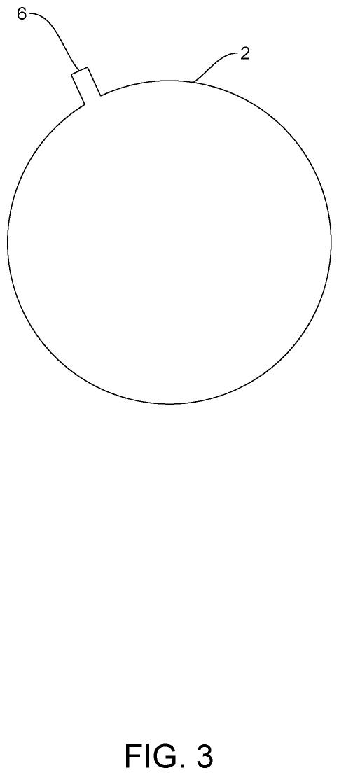

Referring to FIG. 3 there is shown the interior compressible spherical core 2 of the device of FIG. 1. The inflation nipple 6 is also shown, via which the user could adjust the level of deflation of the device 1 to get their desired level of compressibility or deformability of the device 1. As outlined, some embodiments of the device 1 might also use a fixed inflation or fixed compressibility for the spherical core 2.

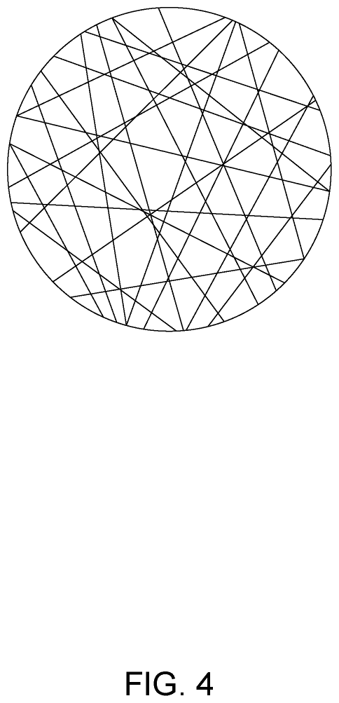

FIG. 4 shows the strengthening layer 4 applied to the outside of the spherical core 2 in a perspective view. As described the strengthening layer 4 consists of a stretchable filament 5 randomly wound around the exterior of the core 2 to provide added strength in managing the deformability of the spherical core 2.

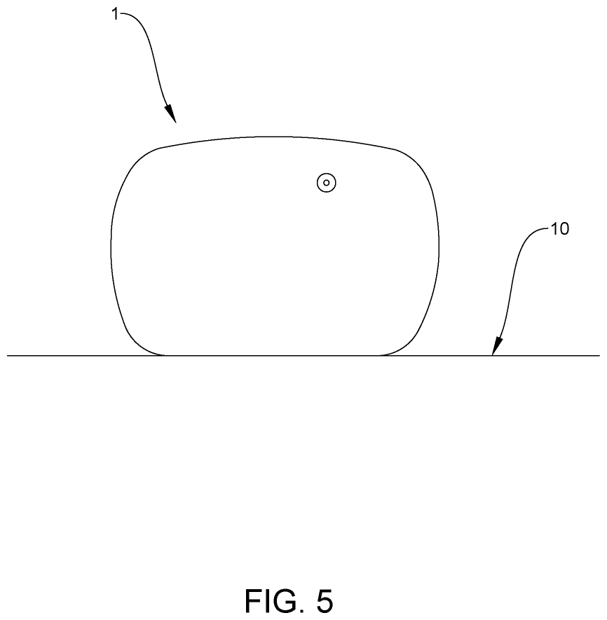

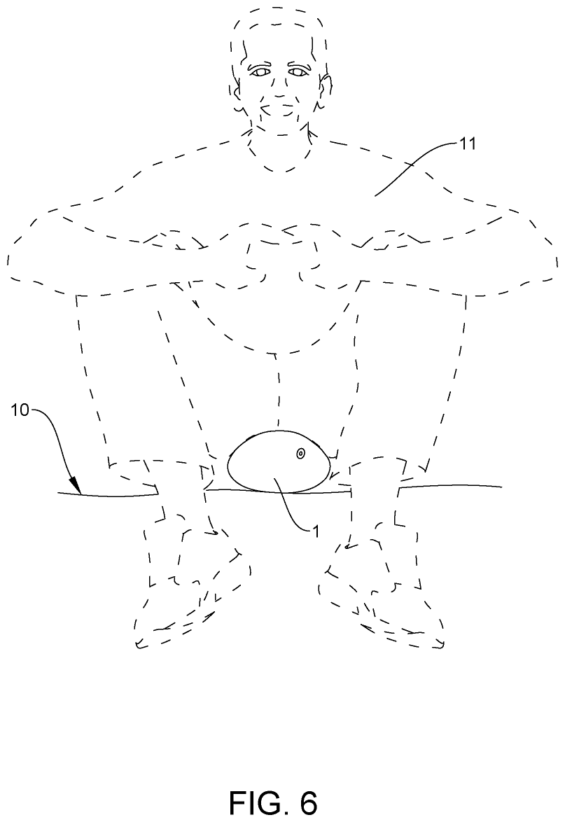

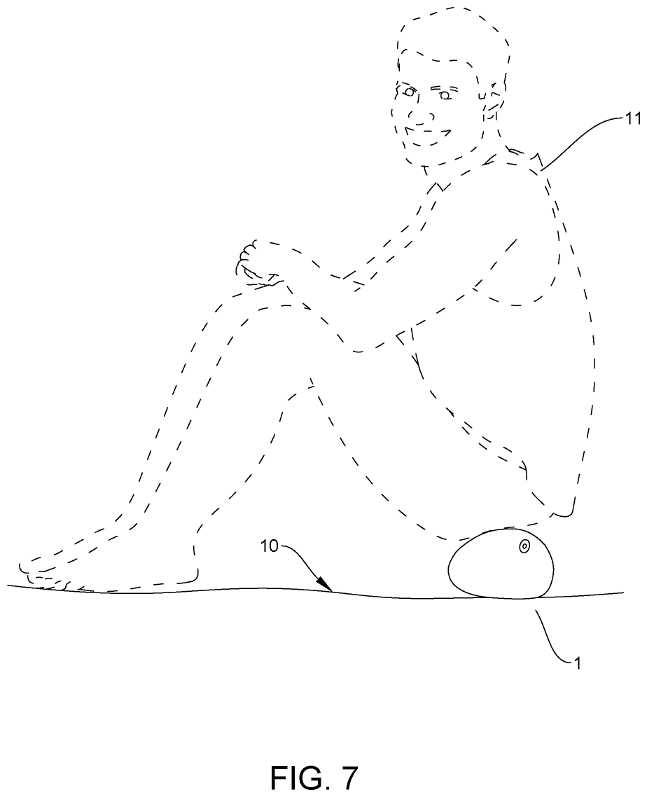

FIG. 5 shows the device 1 of FIG. 1 on a surface 10, modelling the deformity of the device 1 on the surface 10 under weight load (without a person sitting on it). FIG. 6 shows a frontal view of a person 11 sitting on the device of the present invention on a surface 10, and FIG. 7 shows a side view of FIG. 6.

The method of use of the device 1 of the present invention to treat and rehabilitate pelvic floor pain and dysfunction, as demonstrated in FIGS. 6 and 7, is also intended to be covered within the scope of the present invention. The method consists of optionally adjusting the inflation pressure or deformability of the device 1, and then sitting on the device with it in alignment with the pelvic muscles to apply releasing pressure thereon.

It will be apparent to those of skill in the art that by routine modification the present invention can be optimized for use in a wide range of conditions and application. It will also be obvious to those of skill in the art that there are various ways and designs with which to produce the apparatus and methods of the present invention. The illustrated embodiments are therefore not intended to limit the scope of the invention, but to provide examples of the apparatus and method to enable those of skill in the art to appreciate the inventive concept.

Those skilled in the art will recognize that many more modifications besides those already described are possible without departing from the inventive concepts herein. The inventive subject matter, therefore, is not to be restricted except in the scope of the appended claims. Moreover, in interpreting both the specification and the claims, all terms should be interpreted in the broadest possible manner consistent with the context. The terms “comprises” and “comprising” should be interpreted as referring to elements, components, or steps in a non-exclusive manner, indicating that the referenced elements, components, or steps may be present, or utilized, or combined with other elements, components, or steps not expressly referenced.

1. A pelvic floor pain relief device for use by humans comprising a compact multi-layered spherical article consisting of at least three layers as follows:
a. an innermost compressible spherical core, said core having a compressibility rating sufficient to substantially support the weight of a human sitting thereon while minimizing the deformation thereof under the human load;
b. a strengthening layer covering the compressible spherical core, said strengthening layer comprising filament material wound randomly wound around the exterior of the compressible spherical core, whereby the strengthening layer completely covers the spherical core and further minimizes the deformability of the spherical article under human weight load; and
c. an exterior protective layer covering the strengthening layer, retaining the filament of the strengthening layer in relation to the spherical core and providing a cleanable surface.

2. The pelvic floor pain relief device of claim 1 wherein the spherical core is a cellular foam element.

3. The pelvic floor pain relief device of claim 1 wherein the spherical core is an inflatable bladder.

4. The pelvic floor pain relief device of claim 3 wherein the device includes an inflation access port and the inflation of the inflatable bladder can be adjusted by the user to achieve a desired allowable deformity profile or compressibility of the device.

5. The pelvic floor pain relief device of claim 1 wherein the number of layers is more than three, additional layers being added to the spherical article between the spherical core and the exterior protective layer.

6. The pelvic floor pain relief device of claim 1 wherein the spherical core is sized for placement between the hips or in a sitting position in the pelvic floor area of the user.

7. A human pelvic therapy method using a pelvic floor pain relief device comprising a compact multi-layered spherical article consisting of at least three layers as follows:
a. an innermost compressible spherical core, said core having a compressibility rating sufficient to substantially support the weight of a human sitting thereon while minimizing the deformation thereof under the human load;
b. a strengthening layer covering the compressible spherical core, said strengthening layer comprising filament material wound randomly wound around the exterior of the compressible spherical core, whereby the strengthening layer completely covers the spherical core and further minimizes the deformability of the spherical article under human weight load; and
c. an exterior protective layer covering the strengthening layer, retaining the filament of the strengthening layer in relation to the spherical core and providing a cleanable surface;
said method comprising sitting on the pelvic floor pain relief device with it in alignment with the pelvic muscles of the user, wherein releasing pressure will be applied to the pelvic muscles of the user as the device is applied thereto and deformed by the weight of the human thereon.

8. The method of claim 7 wherein the pelvic floor pain relief device used is the pelvic floor pain relief device of any one of claims 1 through 6.

9. The method of claim 7 wherein the compressible spherical core is adjustably inflatable and the method further comprises adjusting the inflation of the compressible spherical core in advance of the user sitting on the device, to adjust the deformability of the device under human load.
